(19) United States
(12) Patent Application Publication
(10) Pub. No.: US 2026/0211235 A1
(43) Pub. Date: Jul. 23, 2026

(54) VEHICULAR DISPLAY DEVICE

(71) Applicant: Yazaki Corporation, Tokyo (JP)

(72) Inventors: Yuki MIYOSHI, Shizuoka (JP); Yasuhiro KATSUMATA, Shizuoka (JP); Naoto TSUBAKIHARA, Shizuoka (JP); Yoshihide TAKADA, Shizuoka (JP); Hiroshi SANO, Shizuoka (JP); Takahiro OSAWA, Shizuoka (JP); Tetsuya SUGANUMA, Shizuoka (JP)

(73) Assignee: Yazaki Corporation, Tokyo (JP)

(21) Appl. No.: 19/577,519

(22) Filed: Mar. 25, 2026

Related U.S. Application Data
(63) Continuation of application No. PCT/JP2024/040503, filed on Nov. 14, 2024.

(30) Foreign Application Priority Data
Dec. 12, 2023 (JP) 2023-209367

(51) Int. Cl. G02B 27/01; G02B 1/11; B60K 35/23

(52) U.S. Cl. CPC G02B 27/0101; G02B 1/11; B60K 35/23; B60K 2360/23

(57) ABSTRACT

A vehicular display device includes a housing that includes a wall portion provided with an opening portion through which display light of an image passes toward an outside, and an image display that is accommodated in the housing and outputs the display light of the image. Further, the vehicular display device includes a reflection mirror that is accommodated in the housing and reflects the display light of the image toward a reflector arranged in front of a vehicle occupant. At an edge portion of an upper portion of the reflection mirror, a frame portion that extends along the edge portion and covers the edge portion is arranged.

### CROSS-REFERENCE TO RELATED APPLICATIONS

The present application is a continuation of International Application No. PCT/JP2024/040503, filed on November 14, 2024, and based upon and claims the benefit of priority from Japanese Patent Application No. 2023-209367, filed on December 12, 2023, the entire contents of which are incorporated herein by reference.

### TECHNICAL FIELD

The disclosure relates to a vehicular display device.

### BACKGROUND

JP 2018-140693 A discloses a technique relating to a vehicular display device mounted on a vehicle such as an automobile, which is also referred to a head-up display device. The vehicular display device includes a display (image display) that generates and outputs display light, a reflection mirror that reflects the display light emitted from the display toward a projection target (reflector arranged in front of a vehicle occupant), and a housing that accommodates the display and the reflection mirror. The vehicular display device is configured to allow a driver to visually recognize, as a virtual image, a display image displayed by the display by projecting the display image onto the above-mentioned projection target (reflector) via the reflection mirror or the like.

### SUMMARY OF THE INVENTION

Incidentally, in the above-mentioned vehicular display device, at least one reflection mirror (second mirror) is arranged at a position in the housing so as to face a windshield forming the above-mentioned projection target (reflector). Thus, when external light including sun light enters the housing of the vehicular display device via a wind portion (opening portion), the external light strikes an upper portion of the reflection mirror, and the light is reflected at an edge portion of the upper portion of the reflection mirror. Consequently, reflected light may be displayed on the windshield of the vehicle as an uncomfortable virtual image.

The disclosure has been made in view of such problems in the related art. Further, an object of the disclosure is to provide a vehicular display device capable of suppressing display of an uncomfortable virtual image by avoiding reflection of light at an edge portion of an upper portion of a reflection mirror.

A vehicular display device according to an aspect of the disclosure includes a housing that includes a wall portion provided with an opening portion through which display light of an image passes toward an outside, an image display that is accommodated in the housing and outputs the display light of the image, and a reflection mirror that is accommodated in the housing and reflects the display light of the image toward a reflector arranged in front of a vehicle occupant. At an edge portion of an upper portion of the reflection mirror, a frame portion that extends along the edge portion and covers the edge portion is arranged.

According to the disclosure, it is possible to provide a vehicular display device capable of suppressing display of an uncomfortable virtual image by avoiding reflection of light at an edge portion of an upper portion of a reflection mirror.

### BRIEF DESCRIPTION OF DRAWINGS

FIG. 1 is a schematic configuration view illustrating an example of a vehicle on which a vehicular display device according to the present embodiment is mounted.

FIG. 2 is a schematic configuration view illustrating an example of the vehicular display device according to the present embodiment.

FIG. 3 is a perspective view of a concave mirror as viewed from a front side.

FIG. 4 is a perspective view of the concave mirror as viewed from a lower side.

FIG. 5 is a perspective view of the concave mirror as viewed from a back side.

FIG. 6 is a front view of the concave mirror.

FIG. 7 is a cross-sectional view taken along the line A-A in FIG. 6.

### DETAILED DESCRIPTION OF THE INVENTION

With reference to the drawings, a vehicular display device according to the present embodiment is described below in detail. Note that the dimensional ratios in the drawings are exaggerated for explanatory purposes, and may differ from the actual ratios.

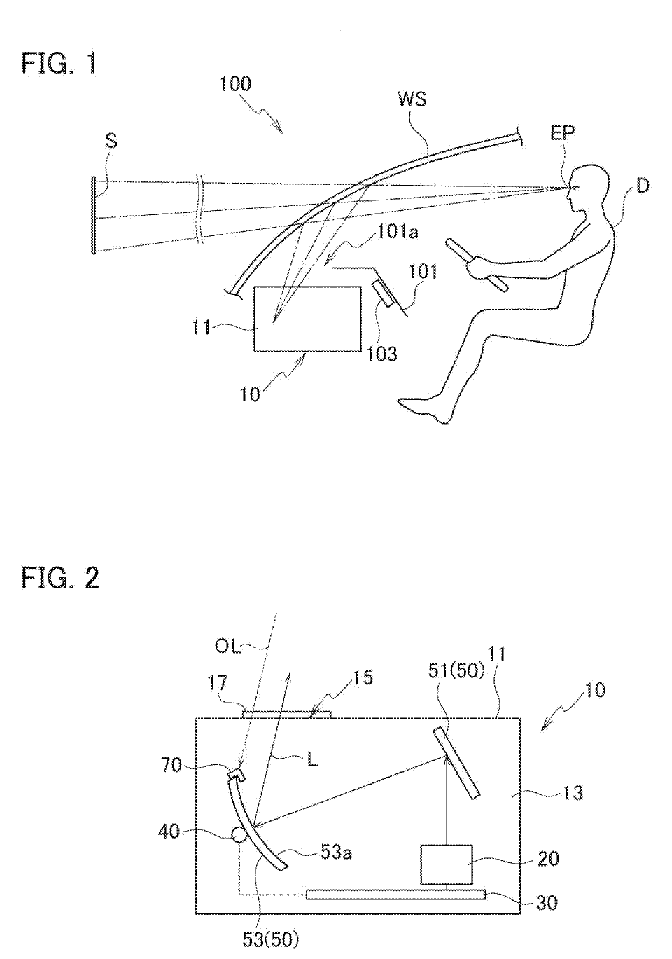

As illustrated in FIG. 1, a vehicular display device 10 according to the present embodiment is a so-called head-up display device that is mounted on a vehicle 100 such as an automobile. The vehicular display device 10 is arranged inside a dashboard 101 together with a meter 103, and displays a virtual image S in front of an eye point EP of the vehicle 100. The eye point EP is a position that is predetermined as a viewpoint position of a vehicle operator (driver D) seated in a driver’s seat.

The vehicular display device 10 is arranged inside the dashboard 101 of the vehicle 100. An upper opening portion 101a is provided in an upper surface of the dashboard 101. The vehicular display device 10 projects an image onto a windshield WS via the upper opening portion 101a. The windshield WS is a reflector arranged in front of the eye point EP of the vehicle 100. For example, the windshield WS has semitransparency, and reflects light incident from the vehicular display device 10 toward the eye point EP. The driver D recognizes an image reflected by the windshield WS as the virtual image S. The virtual image S is recognized by the driver D as if it exists in front of the windshield WS.

As illustrated in FIG. 2, the vehicular display device 10 according to the present embodiment includes a housing 11, a display (image display 20), a controller 30, a driver 40, and a reflection mirror 50.

For example, the housing 11 is obtained by forming a synthetic resin material into a box-like shape, and has an internal space 13 inside. The housing 11 accommodates the image display 20, the controller 30, the driver 40, and the reflection mirror 50, which are described above, in the internal space 13, and holds those components. The housing 11 includes an opening portion 15 that allows communication between an outside of the housing 11 and the internal space 13. The opening portion 15 is provided at a position on an upper wall portion of the housing 11 so as to face the windshield WS. Further, a cover 17 formed of a light-transmissive synthetic resin material (for example, an acrylic resin) is provided to the upper wall portion of the housing 11 so as to close the opening portion 15. The vehicular display device 10 emits display light L of an image from the housing 11 toward the windshield WS via the opening portion 15. The display light L is light that is emitted (output) from the image display 20 and reflected by the reflection mirror 50.

The controller 30 is electrically connected to the image display 20 and the driver 40, and controls operations thereof. The controller 30 is configured by an IC chip or the like, and is driven by power obtained from a battery in the vehicle 100. Further, the controller 30 may be electrically connected to an electronic controller (ECU) in the vehicle 100, and may execute transmission and reception of a signal with the ECU.

The driver 40 has, for example, a structure in which a motor and gears are combined, and is configured to change (adjust) a reflection angle of the display light L by a concave mirror 53, which is described later. The driver 40 is connected to the controller 30, and is driven in accordance with a drive signal from the controller 30. The driver 40 has, for example, a structure in which a gear (pinion) attached to a rotation shaft of the motor and a plurality of teeth (racks) provided on a side opposite to a reflection surface 53a of the concave mirror 53 are meshed with each other. When the driver 40 receives the drive signal from the controller 30, the rotation shaft of the motor is rotated. Power of the motor is transmitted to the concave mirror 53 through meshing between the gear on the motor side and the teeth on the concave mirror 53 side. With this, the concave mirror 53 is rotated, and the reflection angle of the display light L by the concave mirror 53 is changed (adjusted).

The reflection mirror 50 is arranged in an optical path of the display light L from the image display 20 to the windshield WS, and reflects the display light L emitted from the image display 20 toward the windshield WS. The reflection mirror 50 of the present embodiment includes a planar mirror 51 and the concave mirror 53.

The planar mirror 51 has a reflection surface formed by a planar surface, and is arranged at a position facing the image display 20. The planar mirror 51 totally reflects the display light L emitted from the image display 20 toward the concave mirror 53 by the reflection surface. A reflective layer may be formed on the reflection surface of the planar mirror 51 by vapor deposition or the like.

The concave mirror 53 includes the reflection surface 53a formed by a concave curved surface (or a convex curved surface), and is arranged at a position facing the opening portion 15 of the housing 11 and in an optical path between the opening portion 15 of the housing 11 and the planar mirror 51. The concave mirror 53 totally reflects the display light L reflected by the planar mirror 51 toward the windshield WS through the opening portion 15. A reflective layer may be formed on the reflection surface 53a by vapor deposition or the like.

The concave mirror 53 of the present embodiment has a function as a magnifying mirror. In other words, the concave mirror 53 reflects and magnifies a display image so that a display image represented by the display light L after being reflected by the concave mirror 53 becomes relatively larger than a display image represented by the display light L before being reflected by the concave mirror 53.

Further, the concave mirror 53 of the present embodiment is rotatably supported by the driver 40, and is capable of changing (adjusting) reflection angles of the display light L and external light OL including sunlight. Here, the external light OL is sunlight that enters the housing 11 through the opening portion 15. In the present embodiment, the external light OL is condensed by being reflected by the concave mirror 53 functioning as a magnifying mirror, and is directed toward the image display 20 via the planar mirror 51.

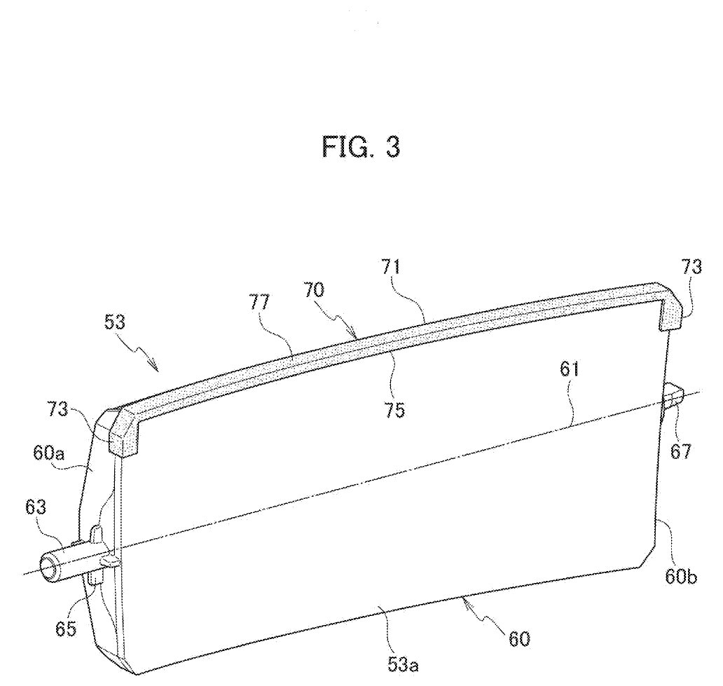

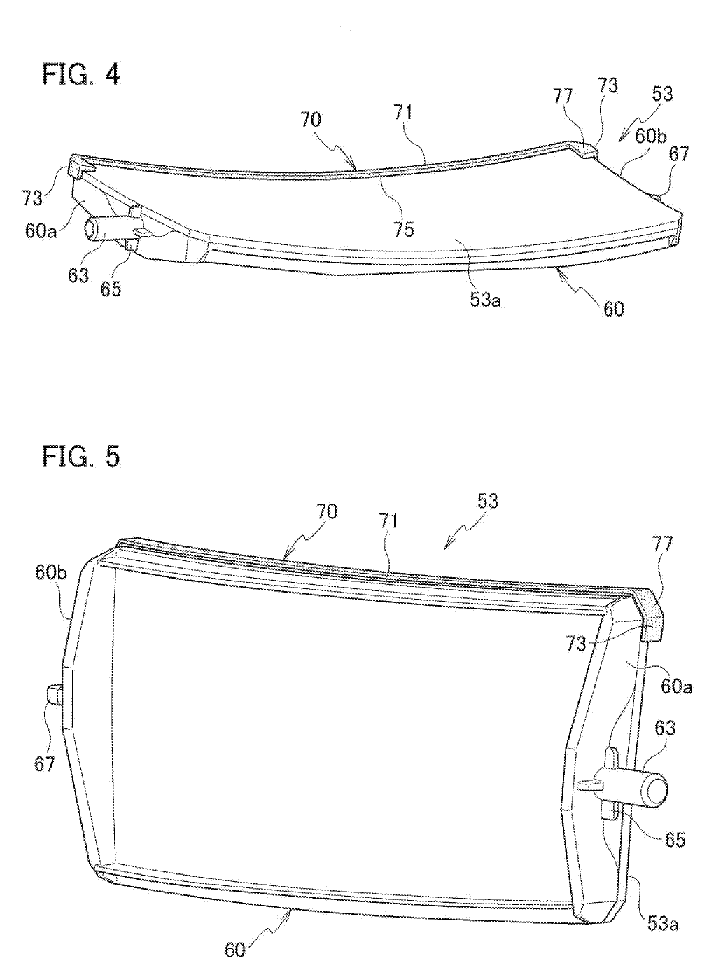

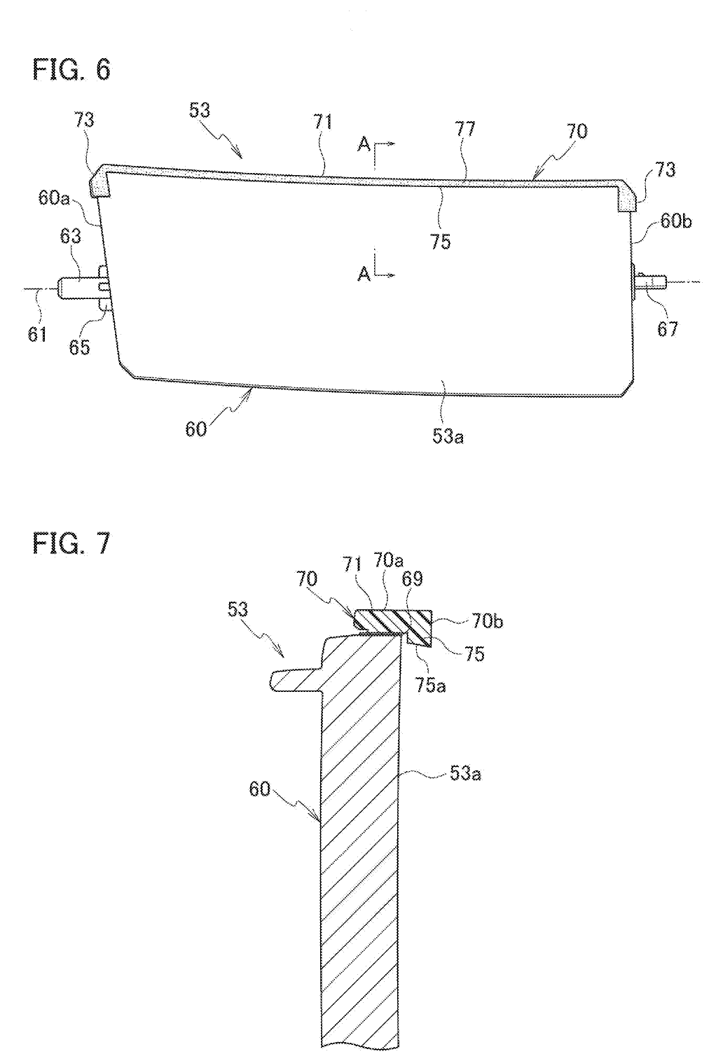

As illustrated in FIG. 3 to FIG. 6, the concave mirror 53 of the present embodiment includes a main body portion 60 formed in a substantially rectangular shape in a front view, and is rotatable about an axis line 61 extending along a longitudinal direction (left-right direction) of the main body portion 60 as a rotation center. The main body portion 60 is, for example, integrally molded from a synthetic resin material. The main body portion 60 includes a first side surface 60a and a second side surface 60b. The first side surface 60a and the second side surface 60b are left and right side surfaces facing the longitudinal direction (left-right direction) of the main body portion 60. The first side surface 60a and the second side surface 60b face directions opposite to each other.

On the first side surface 60a, an input shaft 63 is formed so as to protrude. The input shaft 63 is a driven shaft that is rotated by receiving an output torque of the motor of the driver 40. The input shaft 63 is formed, for example, in a cylindrical shape having a circular cross-sectional shape. Further, the input shaft 63 includes an engagement protrusion portion 65 that protrudes from the first side surface 60a. The engagement protrusion portion 65 is provided to restrict the input shaft 63 from being disengaged from the motor side of the driver 40.

On the second side surface 60b, a supported shaft 67 is formed so as to protrude. The supported shaft 67 is arranged coaxially with the input shaft 63, and is rotatably supported by a bearing member, which is omitted in illustration. The supported shaft 67 is formed, for example, in a prismatic shape having a substantially rectangular cross-sectional shape.

As illustrated in FIG. 3 to FIG. 7, in order to avoid reflection of the external light OL at an edge portion 69 of an upper portion of the concave mirror 53, a frame portion (bezel portion 70) that extends along the edge portion 69 and covers the edge portion 69 is arranged at the edge portion 69 of the upper portion of the concave mirror 53. The bezel portion 70 is, for example, integrally molded from a synthetic resin material, and is mounted (fixed) to the upper portion of the concave mirror 53.

The bezel portion 70 includes a first bezel portion 71 that extends along a longitudinal direction (left-right direction) of the concave mirror 53, and a pair of left and right second bezel portions 73 and 73 that extend from respective left and right end portions of the first bezel portion 71 and extend along a short direction (up-down direction) of the concave mirror 53. Further, the first bezel portion 71 and the pair of left and right second bezel portions 73, 73 each include a reflection surface-side bezel portion 75 arranged in front of the reflection surface 53a of the concave mirror 53 (on the planar mirror 51 side). The bezel portion 70 can be arranged only at a location of the concave mirror 53 where the external light OL may strike, be reflected, and cause an influence. Thus, it is possible to suppress an increase in weight and an increase in size of the concave mirror 53. In other words, the bezel portion 70 may be arranged over an entire periphery of a front side edge portion of the concave mirror 53, but it is possible to suppress an increase in weight and an increase in size of the concave mirror 53 by limiting the bezel portion 70 to be arranged only on the upper portion of the concave mirror 53, as compared with a case where the bezel portion 70 is arranged over the entire periphery.

Further, an anti-reflector 77 subjected to anti-reflection processing to suppress reflection of light is formed on an outer surface of the bezel portion 70. In the present embodiment, the anti-reflector 77 is formed at a location of the bezel portion 70 that does not contact with the concave mirror 53 and is visible in appearance. The anti-reflector 77 may be formed on all outer surfaces including the outer surface that contact with the concave mirror 53, and may be formed at least on an upper surface 70a and a front surface 70b (see FIG. 7). As the above-mentioned anti-reflection processing, for example, emboss processing, coating, or various other types of processing having an effect of suppressing reflection of light on the outer surface of the bezel portion 70 can be adopted. Note that the portion subjected to the anti-reflection processing (the anti-reflector 77) in FIG. 3 to FIG. 6 is indicated by dot hatching.

Further, as illustrated in FIG. 7, an inner side of the bezel portion 70 (a distal end surface 75a of the reflection-surface-side bezel portion 75) adopts a shape inclined with respect to the upper surface 70a of the concave mirror 53 so that the external light OL does not directly strike the distal end surface 75a. In other words, the distal end surface 75a of the reflection-surface-side bezel portion 75 is formed as an inclined surface that is inclined upward while extending from a front side of the concave mirror 53 (the planar mirror 51 side) toward a rear side thereof (a side opposite to the planar mirror 51 side). Thus, it is possible to suppress reflection of the external light OL on the inner side of the bezel portion 70 (at the distal end surface 75a of the reflection-surface-side bezel portion 75) within a driving range of the concave mirror 53 for changing a reflection angle.

As described above, the vehicular display device 10 according to an aspect of the present embodiment includes the housing 11 that includes the wall portion provided with the opening portion 15 through which the display light L of the image passes toward the outside, and the image display 20 that is accommodated in the housing 11 and outputs the display light L of the image. Further, the vehicular display device 10 includes the reflection mirror 50 (concave mirror 53) that is accommodated in the housing 11 and reflects the display light L of the image toward the reflector (windshield WS) arranged in front of the vehicle occupant (driver D). At the edge portion 69 of the upper portion of the reflection mirror 50 (concave mirror 53), the frame portion (bezel portion 70) that extends along the edge portion 69 and covers the edge portion 69 is arranged.

At the upper portion of the concave mirror 53 that the external light OL including sunlight may strike, the bezel portion 70 that covers the edge portion 69 of the upper portion of the concave mirror 53 is arranged. With this, it is possible to avoid reflection of the external light OL at the edge portion 69 of the upper portion of the concave mirror 53. In other words, the bezel portion 70 is arranged at the edge portion 69 of the upper portion of the concave mirror 53. With this, it is possible to suppress display of the uncomfortable virtual image S due to reflection of the external light OL at the edge portion 69 of the upper portion of the concave mirror 53. Consequently, satisfactory display quality of the vehicular display device 10 can be secured.

As described above, according to the present embodiment, it is possible to provide the vehicular display device 10 capable of suppressing display of the uncomfortable virtual image S by avoiding reflection of light (external light OL) at the edge portion 69 of the upper portion of the reflection mirror 50 (concave mirror 53).

In the vehicular display device 10, the anti-reflector 77 that is subjected to the anti-reflection processing may be formed at the outer surface of the frame portion (bezel portion 70) so as to suppress reflection of light.

The anti-reflector 77 that is subjected to the anti-reflection processing is formed on the outer surface of the bezel portion 70. Thus, the bezel portion 70 thus configured can effectively suppress reflection of the external light OL at the outer surface of the bezel portion 70.

In the vehicular display device 10, emboss processing or coating, as the anti-reflection processing, may be applied to the anti-reflector.

The anti-reflector 77 that is subjected to emboss processing or coating as the anti-reflection processing is formed on the outer surface of the bezel portion 70. Thus, the bezel portion 70 thus configured can effectively suppress reflection of the external light OL at the outer surface of the bezel portion 70.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A vehicular display device comprising:
a housing that includes a wall portion provided with an opening portion through which display light of an image passes toward an outside;
an image display that is accommodated in the housing and outputs the display light of the image; and
a reflection mirror including a reflection surface that is accommodated in the housing and reflects the display light of the image toward a reflector arranged in front of a vehicle occupant,
wherein
at an edge portion of an upper portion of the reflection mirror, a frame portion that extends along the edge portion and covers the edge portion is arranged,
and wherein
the frame portion includes an upper surface that is arranged above the reflection mirror, and a front surface that is arranged in front of the reflection surface of the reflection mirror, and
an anti-reflector that is subjected to anti-reflection processing is formed at least on the upper surface and the front surface of an outer surface of the frame portion so as to suppress reflection of light.

2. The vehicular display device according to claim 1, wherein
emboss processing or coating, as the anti-reflection processing, is applied to the anti-reflector.
